(19) United States
(12) Patent Application Publication
(10) Pub. No.: US 2024/0004636 A1
(43) Pub. Date: Jan. 4, 2024

(54) MOBILITY SERVICE PROVIDING SYSTEM, IN-VEHICLE DEVICE, AND APPLICATION USABILITY DETERMINATION METHOD

(71) Applicant: DENSO CORPORATION, Kariya-city (JP)

(72) Inventor: Koichiro TAKEUCHI, Kariya-city (JP)

(21) Appl. No.: 18/340,955

(22) Filed: Jun. 26, 2023

(30) Foreign Application Priority Data
Jul. 4, 2022 (JP) 2022-107905

(51) Int. Cl. G06F 8/65

(52) U.S. Cl. CPC G06F 8/65

(57) ABSTRACT

A mobility service providing system includes an application database storing a hardware requirement required for executing an application program. A basic information obtainer obtains basic information that is hardware information regarding functions of a vehicle. An additional information obtainer obtains hardware information regarding a peripheral device group detachably attached to the vehicle. An information abstractor coverts obtained hardware information into information in a common format. An application provider compares hardware requirements associated with the application program with abstracted hardware information regarding the in-vehicle device to which the application program is downloaded, and determines usability of the application program in the in-vehicle device.

### CROSS REFERENCE TO RELATED APPLICATION

The present application is based on and claims the benefit of priority of Japanese Patent Application No. 2022-107905, filed on Jul. 4, 2022, the disclosure of which is incorporated herein by reference.

### TECHNICAL FIELD

The present disclosure relates to technology for obtaining an application program executed on an in-vehicle device.

### BACKGROUND

There has been known a technique of determining, when installing an application program (hereinafter, abbreviated as AP) to an information device after being downloaded from a server, whether AP is installable by comparing (a) information on a device which is required for executing AP and (b) information on a providable device that is providable as installation destination of AP (hereinafter, referred to as “providable device information”).

### SUMMARY

One aspect of the present disclosure is a mobility service providing system. The system includes: a server configured to provide an application program for performing a process using a function of a vehicle; an in-vehicle device installed in the vehicle and configured to obtain the application program from the server and execute the obtained application program; a requirement storage unit configured to store a hardware requirement required for executing the application program; a first obtainer configured to obtain basic information that is information on the function of the vehicle in which the in-vehicle device is installed; a second obtainer configured to obtain additional information that is information on a peripheral device detachably attached to the vehicle; an abstractor configured to convert the basic information and the additional information into abstracted information, the abstracted information being information in a common format independent from the vehicle and the peripheral device; and a usability determiner configured to determine, when a request for downloading the application program from the server to the in-vehicle device is made, whether the application program is usable in the in-vehicle device by comparing (a) the hardware requirement associated with the application program to be downloaded with (b) the abstracted information possessed by the in-vehicle device to which the application program is to be downloaded.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing a configuration of a mobility service providing system;

FIG. 2 is a block diagram showing a functional configuration of a cloud server and an in-vehicle device;

FIG. 3 is a flowchart showing an assembly-time process performed by a control unit of the in-vehicle device;

FIG. 4 is a flowchart showing a restart-time process performed by the control unit of the in-vehicle device;

FIG. 5 is a flowchart showing a user setting synchronization process performed by the control unit of the in-vehicle device;

FIG. 6 is a flowchart showing a server-side synchronization process performed by the control unit of the cloud server; and

FIG. 7 is a flowchart showing a download process performed by the control unit of the cloud server.

### DETAILED DESCRIPTION OF EMBODIMENTS

Next a relevant technology will be described first only for understanding the following embodiments.

After performing detailed examination of the conventional technique, the applicants have found the following issues. That is, when the conventional technique is applied to a vehicle, only the information on the device which is originally installed in the vehicle is considered as the providable device information, and information on an extension device installed later on the vehicle is not taken into consideration. Therefore, there has been a problem that AP usability on (i.e., installability to) the vehicle is not appropriately determined.

It is one of objectives of the present disclosure to provide a technique for appropriately determining whether an application program is usable on an in-vehicle device regardless of whether an extension device is attached to a vehicle.

A first aspect of the present disclosure is a mobility service providing system. The system includes: a server configured to provide an application program for performing a process using a function of a vehicle; an in-vehicle device installed in the vehicle and configured to obtain the application program from the server and execute the obtained application program; a requirement storage unit configured to store a hardware requirement required for executing the application program; a first obtainer configured to obtain basic information that is information on the function of the vehicle in which the in-vehicle device is installed; a second obtainer configured to obtain additional information that is information on a peripheral device detachably attached to the vehicle; an abstractor configured to convert the basic information and the additional information into abstracted information, the abstracted information being information in a common format independent from the vehicle and the peripheral device; and a usability determiner configured to determine, when a request for downloading the application program from the server to the in-vehicle device is made, whether the application program is usable in the in-vehicle device by comparing (a) the hardware requirement associated with the application program to be downloaded with (b) the abstracted information possessed by the in-vehicle device to which the application program is to be downloaded.

According to such a configuration, whether the in-vehicle device satisfies the hardware requirement required by the application program (i.e., whether the application program is usable in the in-vehicle device) is appropriately determinable not only in view of the functions of the vehicle but also in view of the functions of the peripheral device.

Further, when determining whether the AP is executable, not only the functions of the vehicle but also the functions of the peripheral device are taken into consideration. Therefore, it is possible to develop a new business model such as (a) the peripheral device is customized according to the AP of interest to use while minimizing the functions of vehicle, (b) a vehicle to rent is selected in a rental service or the like based on installed AP of interest to use, or the like.

A second aspect of the present disclosure is an in-vehicle device obtaining from a server and executing an application program for performing a process using a function of a vehicle. The in-vehicle device includes: first obtainer configured to obtain basic information that is information on the function of the vehicle in which the in-vehicle device is installed; a second obtainer configured to obtain additional information that is information on a peripheral device detachably attached to the vehicle; an abstractor configured to convert the basic information and the additional information into abstracted information, the abstracted information being information in a common format independent from vehicle and the peripheral device; and a provider configured to provide the server with the abstracted information as information for determining whether the application program is downloadable.

According to such a configuration, the in-vehicle device is usable as a component device of the mobility service providing system described above.

A third aspect of the present disclosure is a usability determination method determining usability of an application program in an in-vehicle device that is installed in a vehicle. The application program is implemented for performing a process using a function of the vehicle. The method includes: obtaining basic information that is information on the function of the vehicle in which the in-vehicle device is installed and additional information that is information on a peripheral device detachably attached to the installed vehicle; converting the basic information and the additional information into abstracted information, the abstracted information being in a common format independent from the vehicle and the peripheral device; and determining usability of the application program in the in-vehicle device by comparing a hardware requirement required for executing the application program that was designated and the abstracted information possessed by the in-vehicle device that executes the application program.

According to such a configuration, it is possible to obtain the same effects as those of the mobility service providing system as described above.

The following describes an embodiment of the present disclosure with reference to the drawings.

### 1. Hardware Configuration

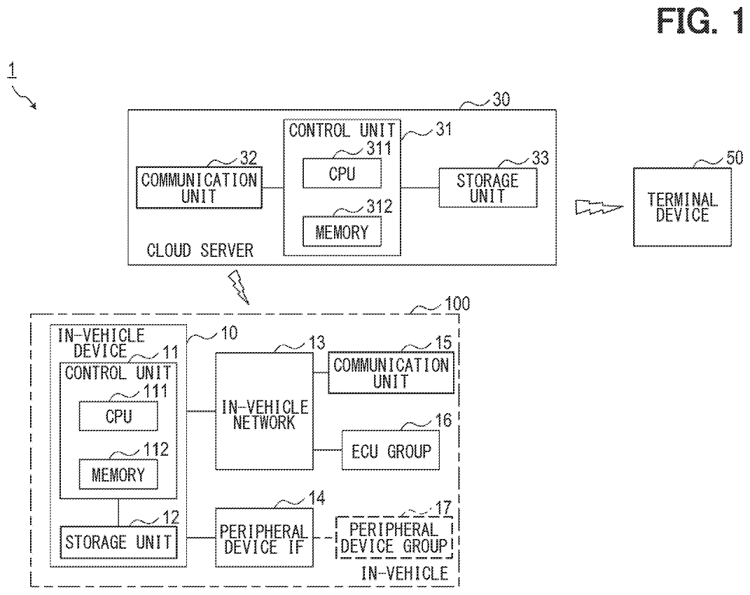

As shown in FIG. 1, a mobility service providing system 1 of the present embodiment includes a plurality of in-vehicle devices 10 each mounted on an individual vehicle 100, a cloud server 30, and a terminal device 50. The vehicle 100 may have an automatic driving function in addition to a manual driving function. The vehicle 100 may be a hybrid vehicle having an engine and an electric motor as driving power sources. The vehicle 100 is not necessarily limited to a vehicle having an automatic driving function and a hybrid vehicle, and may be a vehicle having only a manual driving function, or a vehicle having only an engine or only an electric motor as a driving power source. Hereinafter, the vehicle on which the in-vehicle device 10 is mounted is simply referred to as a vehicle 100.

The in-vehicle device 10 is connected to an in-vehicle network 13. The in-vehicle network 13 can use, for example, CAN (Controller Area Network), Ethernet, or the like. Both CAN and Ethernet are registered trademarks.

The in-vehicle device 10 is connected to a communication unit 15 and an ECU (Electric Control Unit) group 16 via the in-vehicle network 13. The in-vehicle device 10 wirelessly communicates with the cloud server 30 via the communication unit 15. Further, the in-vehicle device 10 collects information (hereinafter referred to as basic information) regarding the functions provided in the vehicle 100 by communicating with the ECU group 16.

The basic information is information on hardware that the vehicle 100 originally has. The basic information may include, for example, hardware type, performance, installation position, and the like. Types of hardware may include, for example, imaging equipment, display equipment, audio equipment, lighting equipment, sensors, actuators, and the like. Sensors may include, for example, sensors for detecting the behavior and state of the vehicle, such as vehicle speed sensors, acceleration sensors, and steering angle sensors, as well as sensors, such as radar, lidar, sonar, and cameras, for grasping conditions inside and outside the vehicle. The actuators may include, for example, a device for opening and closing doors and windows, for locking doors, for adjusting seat positions, directions of mirrors and sensors, and the like. Hardware performance may include, for example, resolution, frame rate, angle of view, movable range, and the like. The installation position of the device may include, for example, front, rear, right side, left side of the vehicle, and the interior of the vehicle.

The in-vehicle device 10 is connected to a peripheral device IF (Interface) 14 to which peripheral devices are connected. The in-vehicle device 10 collects, via the peripheral device IF 14, information (hereinafter referred to as additional information) regarding the functions of a peripheral device group 17 connected to the peripheral device IF 14. The peripheral device group 17 is additional devices (aftermarket devices) retrofitted to the vehicle 100, and may include, for example, imaging equipment, display equipment, audio equipment, lighting equipment, sensors, actuators, and the like, similar to the hardware described above. The content of the additional information is the same as that of the basic information. Hereinafter, the basic information and the additional information may also be collectively referred to as hardware information.

The in-vehicle device 10 includes a control unit 11 and a storage unit 12. The control unit 11 includes a CPU 111 and a semiconductor memory such as RAM or ROM (hereinafter referred to as a memory 112). The functions of the control unit 11 are realized by the CPU 111 executing programs stored in the memory 112. A method corresponding to the program is performed when the program is executed.

The storage unit 12 at least stores the basic information and the additional information obtained via the in-vehicle network 13 and the peripheral device IF 14. The cloud server 30 includes a control unit 31, a communication unit 32, and a storage unit 33. The control unit 31 includes a CPU 311 and a semiconductor memory such as RAM or ROM (hereinafter referred to as a memory 312).

The functions of the control unit 31 are realized by the CPU 311 executing the programs stored in the memory 312. A method corresponding to the program is performed when the program is executed.

The cloud server 30 is a server installed to provide application programs to the in-vehicle device 10 in response to requests from users. An application program (hereinafter referred to as an AP) is a program for performing various processes using functions of the vehicle 100.

The cloud server 30 performs wireless communication with the in-vehicle device 10 and the terminal device 50 via the communication unit 32. The storage unit 33 stores an AP provided to the in-vehicle device 10, hardware information provided from the in-vehicle device 10, and the like.

The terminal device 50 is, for example, a portable terminal such as a smart phone, a tablet terminal, a notebook PC or the like possessed by the user of the vehicle 100. The user may be an owner of vehicle 100 or a person who has obtained the right to use the vehicle 100 temporarily.

### 2. Functional Configuration

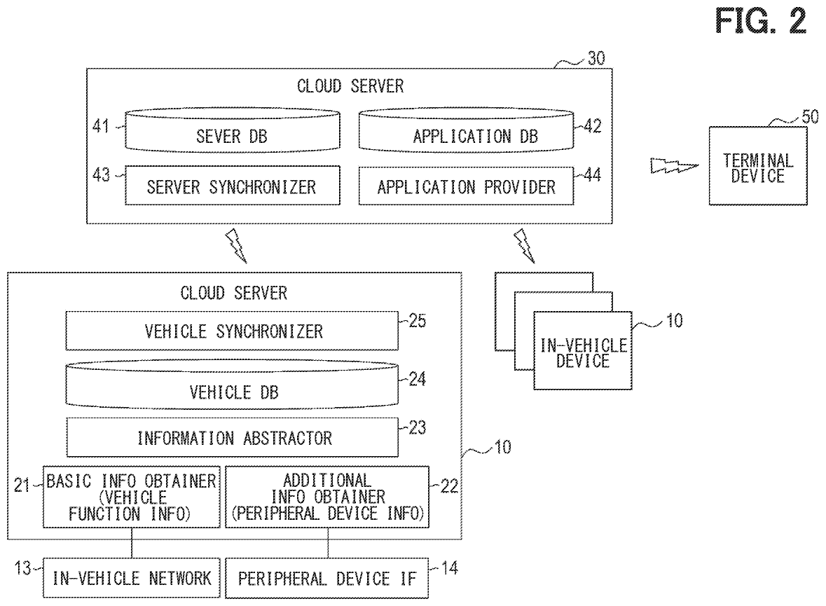

The functions provided by the in-vehicle device 10 and the cloud server 30 for the in-vehicle device 10 to download and execute an AP from the cloud server 30 are described with reference to FIG. 2.

The in-vehicle device 10 includes a basic information obtainer 21, an additional information obtainer 22, an information abstractor 23, a vehicle database (DB) 24, and a vehicle synchronizer 25. The vehicle DB 24 is provided in the storage unit 12. The basic information obtainer 21, the additional information obtainer 22, the information abstractor 23, and the vehicle synchronizer 25 are realized by processes executed by the control unit 11.

The basic information obtainer 21 obtains the basic information via the in-vehicle network 13. The basic information obtainer 21 obtains a unique frame format, a bit assignment, etc. used in the in-vehicle network 13 from the vehicle type of the vehicle 100, and extracts the basic information according to the obtained information.

The additional information obtainer 22 obtains the additional information via the peripheral device IF 14. The information abstractor 23 further abstracts the hardware information obtained by merging the basic information obtained from the basic information obtainer 21 and the additional information obtained from the additional information obtainer 22, and stores the information in the vehicle DB 24.

The information abstractor 23 abstracts the hardware information by applying it to a predefined data structure. The data structure may include, for example, an item for writing to which of a preset category the type of hardware, which is the source of information, belongs. Further, the data structure may include, for example, an item for writing the hardware performance, which is expressed in a specific format according to a hardware manufacturer, a model, and the like after converting it into a common format (e.g., the same unit system).

The hardware information may include the installation position, installation state, and the like of the hardware that is the source of the information. In case of a retrofitted peripheral device, it is difficult to automatically identify the hardware information indicating the installation position and installation state. Therefore, it may be set manually. A method of complementing the hardware information by manual setting will be described later.

The vehicle synchronizer 25 transmits the hardware information stored in the vehicle DB 24 to the cloud server 30 when the vehicle 100 is activated or similar timing. Further, when the vehicle synchronizer 25 receives a notification from the cloud server 30 indicating that the hardware information has been updated by manual setting, the vehicle synchronizer 25 updates the hardware information stored in the vehicle DB 24 according to the content of the received notification. In such manner, the vehicle synchronizer 25 synchronizes the hardware information possessed by the in-vehicle device 10 and the hardware information possessed by the cloud server 30.

The cloud server 30 includes a server database (hereinafter referred to as a server DB) 41, an application database (hereinafter referred to as an application DB) 42, a server synchronizer 43 and an application provider 44. The server DB 41 and the application DB 42 are provided in the storage unit 33. The server synchronizer 43 and the application provider 44 are implemented by processes executed by the control unit 31.

The server DB 41 stores, in association with the in-vehicle device 10 that is the provider (i.e., the source of information), the hardware information provided from each of the in-vehicle devices 10. The hardware information stored in the server DB 41 can be manually updated via the terminal device 50. Further, in the server DB 41, information specific to the vehicle type related to how to obtain the basic information, such as bit assignment of communication frames used in the in-vehicle network 13, is stored in association with the vehicle type of the vehicle 100.

The application DB 42 associates and stores an AP and an application manifest describing hardware requirements required for executing the AP. The hardware requirements are defined by information that may be included in the hardware information.

The server synchronizer 43 updates the contents of the server DB 41 with the hardware information provided from each of the in-vehicle devices 10. Further, when the hardware information stored in the server DB 41 is updated via the terminal device 50, the server synchronizer 43 transmits the updated hardware information to the in-vehicle device 10 that is associated with the updated hardware information. In such manner, the hardware information stored in the server DB 41 and the hardware information stored in the vehicle DB 24 are synchronized.

The application provider 44 receives instructions from the user operating the terminal device 50 via an application store, which is a homepage that can be browsed from the terminal device 50. The application provider 44 reads an AP designated by the user (hereinafter referred to as a designated AP) from the application DB 42, and provides the designated AP to the in-vehicle device 10 designated by the user (hereinafter a designated in-vehicle device). At this time, the application provider 44 reads the hardware information associated with the designated in-vehicle device from the server DB 41, and reads the application manifest associated with the designated application from the application DB 42. Then, the application provider 44 compares the read hardware with the application manifest, and, if the hardware provided by the designated in-vehicle device satisfies the hardware requirements required by the designated AP, permits to provide the designated AP to the designated in-vehicle device.

The user of the vehicle 100 can arbitrarily set and update the contents of the hardware information stored in the server DB 41 via the terminal device 50. Also, the user of the vehicle 100 can install the specified application on the specified in-vehicle device 10 via the terminal device 50.

### 3. Processing

[3-1. Assembly-Time Process]

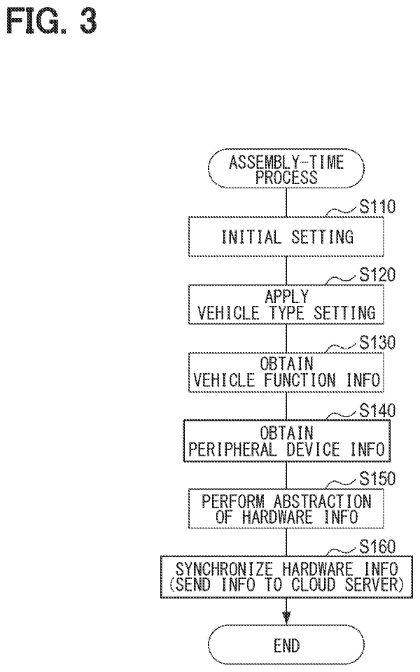

The assembly-time process performed by the control unit 11 when the in-vehicle device 10 is activated for the first time after being assembled to the vehicle 100 is described with reference to the flowchart of FIG. 3.

In S110, the control unit 11 performs initial setting for obtaining, via the terminal device 50, information such as the vehicle type of the vehicle 100 (hereinafter referred to as own vehicle) to which the in-vehicle device 10 is assembled. Subsequently in S120, the control unit 11, based on the obtained vehicle type of the own vehicle, obtains vehicle-type dependent information related to obtaining the basic information (for example, bit assignment of communication frames, etc.) from the cloud server 30 via the communication unit 15. By using this unique information, the basic information can be collected via the in-vehicle network 13.

Subsequently in S130, the control unit 11 obtains the basic information, which is the hardware information regarding the functions of the vehicle 100, via the in-vehicle network 13. Subsequently in S140, the control unit 11 obtains the additional information, which is the hardware information regarding the functions of the peripheral device group 17 connected to the peripheral device IF 14, via the peripheral device IF 14.

Subsequently in S150, the control unit 11 abstracts the hardware information obtained in S130 and S140 by converting it into a common format independent of vehicle type. Subsequently in S160, the control unit 11 stores the abstracted hardware information in the vehicle DB 24, transmits the information to the cloud server 30, and ends the process. Of the abstracted hardware information stored in the vehicle DB 24, at least basic information is stored in a non-volatile memory.

[3-2. Restart-Time Process]

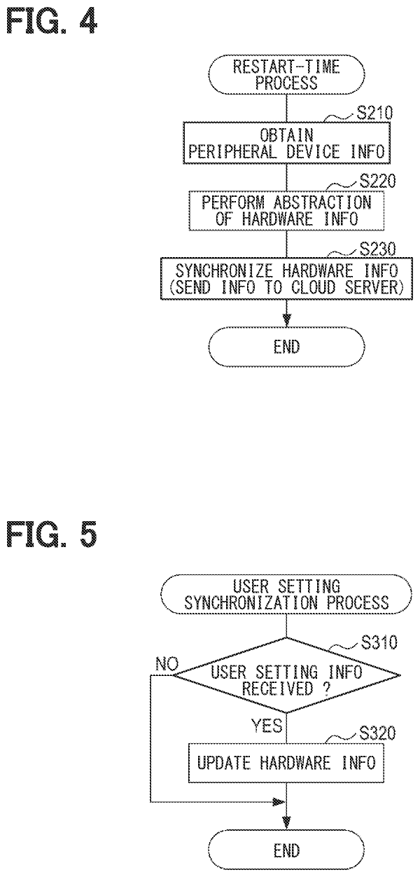

After the control unit 11 of the in-vehicle device 10 performs the assembly-time process, the restart-time process performed by the control unit 11 every time the in-vehicle device 10 is restarted is explained using the flowchart of FIG. 4.

In S210, the control unit 11 obtains the additional information, which is the hardware information regarding the functions of the peripheral device group 17 connected to the peripheral device IF 14, via the peripheral device IF 14. Subsequently in S220, the control unit 11 abstracts the hardware information obtained in S210 by converting it into a common format that does not depend on the vehicle type.

Subsequently in S230, the control unit 11 stores the hardware information abstracted in S220 in the vehicle DB 24, and transmits the hardware information to the cloud server 30, thereby terminating the process. That is, the basic information of the hardware information is collected only once when the in-vehicle device 10 is assembled, and the information is synchronized between the in-vehicle device 10 and the cloud server 30. The additional information among the hardware information is collected every time the in-vehicle device 10 is activated, and the information is synchronized between the in-vehicle device 10 and the cloud server 30 on such occasion. In the present embodiment, only the additional information is repeatedly collected at the time of restarting. However, the basic information may also be repeatedly collected at the time of restarting.

[3-3. User Setting Synchronization Process]

The user setting synchronization process that is repeatedly performed by the control unit 11 of the in-vehicle device 10 while the in-vehicle device 10 is operating is described using the flowchart of FIG. 5.

In S310, the control unit 11 determines whether or not user setting information has been received from the cloud server 30. If it has been received, the process proceeds to S320, and if it has not been received, the process ends.

In S320, the control unit 11 updates the hardware information stored in the vehicle DB 24 according to the update contents of the hardware information indicated in the received user setting information, and completes the process. By such an update, the control unit 11 synchronizes the hardware information of the in-vehicle device 10 with the hardware information of the cloud server 30.

[3-4. Server-Side Synchronization Process]

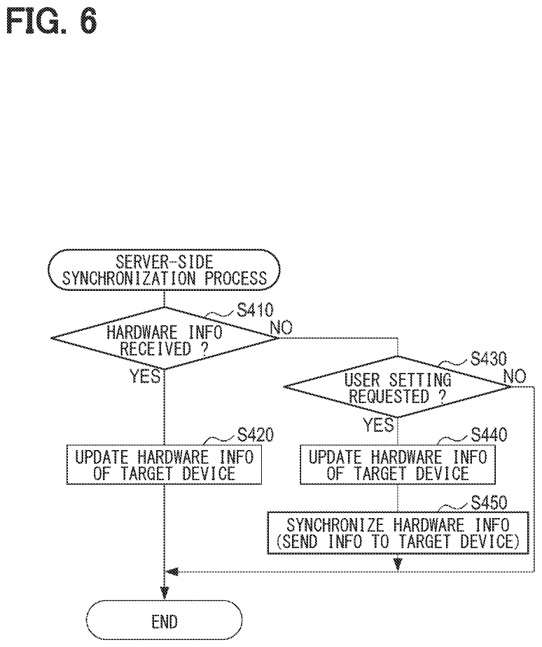

The server-side synchronization process repeatedly performed by the control unit 31 of the cloud server 30 is described using the flowchart of FIG. 6.

In S410, the control unit 31 determines whether or not the hardware information has been received from the in-vehicle device 10. If the hardware information has been received, the process proceeds to S420, and if the hardware information has not been received, the process proceeds to S430.

In S420, the control unit 31 associates the received hardware information with the in-vehicle device 10 (hereinafter referred to as a target in-vehicle device) that has transmitted the hardware information, stores the received hardware information in the server DB 41, and ends the process. If the hardware information of the target in-vehicle device is already stored, the stored hardware information is updated with the received hardware information.

In S430, the control unit 31 determines whether or not a user setting request of hardware information has been received from the terminal device 50. If the user setting request has been received, the process proceeds to S440, and, if the user setting request has not been received, the process terminates.

In S440, the control unit 31 updates the hardware information (hereinafter referred to as target information) stored in the server DB 41 in association with the in-vehicle device 10 (i.e., the target in-vehicle device) indicated in the user setting request with the hardware information indicated in the user setting request.

Subsequently in S450, the control unit 31 transmits the target information to the target in-vehicle device so that the hardware information updated by the user setting request is reflected in the hardware information possessed by the target in-vehicle device, and the process ends.

The hardware information to be updated by the user setting request is, for example, information on the performance of a peripheral device for which information required for abstraction is not prepared, or information on the installation position and orientation of a peripheral device that cannot be automatically obtained by the in-vehicle device 10.

[3-5. Download Process]

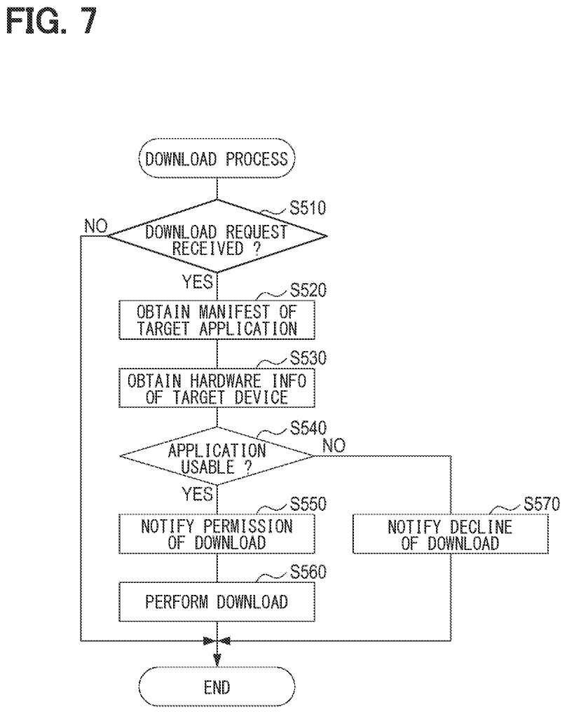

The download process repeatedly performed by the control unit 31 of the cloud server 30 is described using the flowchart of FIG. 7.

In S510, the control unit 31 determines whether or not a download request has been received from the terminal device 50. If the download request has been received, the process proceeds to S520, and if the download request has not been received, the process ends.

Hereinafter, the application program indicated in the download request is referred to as the target AP, and the in-vehicle device 10 that is a download destination is referred to as the target in-vehicle device. In S520, the control unit 31 obtains the application manifest associated with the target AP from the application DB 42.

Subsequently in S530, the control unit 31 obtains the hardware information of the target in-vehicle device from the server DB 41. Subsequently in S540, the control unit 31 determines whether or not the target AP is usable on the target in-vehicle device, and, if the target AP is usable, the process proceeds to S550, and if it is not usable, the process proceeds to S570. Specifically, the application manifest obtained in S520 and the hardware information obtained in S530 are compared, and if the target in-vehicle device satisfies the hardware requirements indicated in the application manifest, it is determined that it is usable, and, if it does not satisfy the requirements, it is determined as unusable.

In S550, the control unit 31 notifies the terminal device 50, which is the source of the download request (hereinafter referred to as a requesting terminal), of download permission. Subsequently in S560, the control unit 31 downloads the target AP to the target in-vehicle device, and ends the process. Note that, when the download of the target AP to the target in-vehicle device is complete, the target in-vehicle device installs the target AP and executes the target AP.

In S570, the control unit 31 notifies the requesting terminal of the download refusal, and terminates the process.

### 4. Terminology Correspondence

In the present embodiment, the application DB 42 corresponds to a requirement storage unit in the present disclosure. The basic information obtainer 21 and the processing of S130 correspond to a first obtainer in the present disclosure. The additional information obtainer 22 and the processing of S140 correspond to a second obtainer in the present disclosure. The information abstractor 23 and the processing of S150 and S220 correspond to an abstractor in the present disclosure. The application provider 44 and the processing of S520 to S540 correspond to a usability determiner in the present disclosure. The processing of S110 corresponds to a specific information obtainer in the present disclosure. The vehicle synchronizer 25, the server synchronizer 43, and the processing of S160, S230, S310 to S320, and S410 to S450 correspond to an information synchronizer in the present disclosure. The vehicle synchronizer 25, the server synchronizer 43, and the processing of S160 and S230 correspond to a provider in the present disclosure. The processing of S430 to S450 corresponds to a user setting unit in the present disclosure. The processing of S130 to S140 and S210 corresponds to an obtainer step in the present disclosure. The processing of S150 and S220 corresponds to an abstractor step in the present disclosure. The processing of S520 to S540 corresponds to a determiner step in the present disclosure.

### 5. Advantageous Effects

According to the embodiment described in detail above, the following effects are achievable. (1) In the mobility service providing system 1, hardware information (that is, basic information) regarding functions that the vehicle 100 originally has, and hardware information (that is, additional information) regarding the peripheral device group 17 retrofitted to the in-vehicle device 10 are abstracted and managed. Therefore, when adding an AP to the in-vehicle device 10, whether or not the in-vehicle device 10 satisfies the hardware requirements required by the AP, that is, whether or not the AP is executable on the in-vehicle device 10 is appropriately determinable in view of not only the vehicle functions but also the functions of the peripheral device group 17 as well. Further, such a determination result is usable when purchasing an AP or when installing an AP.

(2) In the mobility service providing system 1, not only the vehicle functions but also the functions of the peripheral device group 17 are considered when determining whether or not the AP is executable. Therefore, it is possible to develop new business models such as (a) the peripheral device group 17 is customized according to the AP of interest to use while minimizing the functions of the vehicle 100, (b) the vehicle 100 to rent is selected in a rental service or the like based on installed AP of interest to use, or the like.

### 4. Other Embodiments

The embodiment of the present disclosure is explained thus far, the present disclosure is not limited to the above embodiment, and can be implemented with various modifications being made thereto.
(a) In the above embodiment, the in-vehicle device 10 abstracts the obtained hardware information, and provides it to the cloud server 30. The in-vehicle device 10 may be configured to provide, to the cloud server 30, the hardware information that is not abstracted, and the hardware information may be abstracted on the cloud server 30.
(b) In the above embodiment, the hardware information stored in the cloud server 30 is used when the cloud server 30 determines whether or not the AP is usable. The cloud server 30 may be configured to obtain and use the hardware information stored in the in-vehicle device 10 as necessary. In such case, the cloud server 30 may omit the server DB 41. Further, the control unit 31 of the cloud server 30 obtains the abstracted hardware information from the target in-vehicle device 10 to which the AP is downloaded in S530 of the download process shown in FIG. 7. The processing of S530 in such case corresponds to an abstracted information obtainer.
(c) In the above embodiment, the cloud server 30 determines whether or not the AP is usable. However, the usability of the AP may be determined on the in-vehicle device 10 side, upon receiving the AP and application manifest from the cloud server 30.
(d) Although the cloud server 30 is used in the above embodiment, it may be an on-premises server.
(e) The control units 11, 31 and techniques thereof described in the present disclosure may be implemented by a dedicated computer provided by configuring a processor and a memory programmed to perform one or more functions embodied by a computer program. Alternatively, the control units 11, 31 and techniques thereof described in the present disclosure may be implemented by a dedicated computer provided by configuring the processor with one or more dedicated hardware logic circuits. Alternatively, the control units 11, 31 and techniques thereof described in the present disclosure may be implemented by one or more dedicated computers configured as a combination of (a) a processor and a memory programmed to perform one or more functions, and (b) a processor configured with one or more hardware logic circuits. The computer program may be stored in a computer-readable, non-transitory, tangible storage medium as instructions to be performed by the computer. The method of implementing the function of each part included in the control units 11, 31 does not necessarily include software, and all the functions may be implemented using one or more pieces of hardware.
(f) The multiple functions of one component in the above embodiments may be implemented by multiple components, or a function of one component may be implemented by multiple components. Multiple functions of multiple components may be implemented by one element, or a single function implemented by multiple components may be provided by one element. A part of the configuration of the above embodiment may be omitted as appropriate. At least a part of the configuration of the above embodiments may be added to or replaced with another configuration of the above embodiments.
(g) Further to the mobility service providing system 1 described above, the present disclosure can also be implemented in various forms such as an in-vehicle device 10 and a cloud server 30 serving as components of the mobility service providing system 1, a program for causing a computer to function as the in-vehicle device 10 and the cloud server 30, a non-transitory, tangible storage medium such as a semiconductor memory in which such a program is recorded, and the like, a method for determining application usability, and the like.

What is claimed is:

1. A mobility service providing system, comprising:
a server configured to provide an application program for performing a process using a function of a vehicle;
an in-vehicle device installed in the vehicle and configured to obtain the application program from the server and execute the obtained application program;
a requirement storage unit configured to store a hardware requirement required for executing the application program;
a first obtainer configured to obtain basic information that is information on the function of the vehicle in which the in-vehicle device is installed;
a second obtainer configured to obtain additional information that is information on a peripheral device detachably attached to the vehicle;
an abstractor configured to convert the basic information and the additional information into abstracted information, the abstracted information being information in a common format independent from the vehicle and the peripheral device; and
a usability determiner configured to determine, when a request for downloading the application program from the server to the in-vehicle device is made, whether the application program is usable in the in-vehicle device by comparing (a) the hardware requirement associated with the application program to be downloaded with (b) the abstracted information possessed by the in-vehicle device to which the application program is to be downloaded.

2. The mobility service providing system according to claim 1, wherein
the in-vehicle device is provided with the first obtainer, the second obtainer, and the usability determiner,
the server is provided with the requirement storage unit and the usability determiner, and
the mobility service providing system further includes an information synchronizer configured to synchronize the abstracted information between the in-vehicle device and the server.

3. The mobility service providing system according to claim 1, wherein
the in-vehicle device is provided with the first obtainer, the second obtainer, and the abstractor,
the server is provided with the requirement storage unit and the usability determiner, and
the server is further provided with an abstracted information obtainer configured to obtain the abstracted information from the in-vehicle device to which the application program is downloaded when the usability determiner determines whether the application program is usable.

4. The mobility service providing system according to claim 1, wherein
the in-vehicle device is further provided with a specific information obtainer configured to obtain, when the in-vehicle device is initialized, specific information that is required for grasping a content of the basic information and is described in a format specific to a vehicle type of the vehicle.

5. The mobility service providing system according to claim 1, wherein
the first obtainer is configured to operate at least when the in-vehicle device is activated for first time, and
the second obtainer is configured to operate every time the in-vehicle device is activated.

6. The mobility service providing system according to claim 1, further comprising:
a user setting unit configured to set the abstracted information via an external input.

7. An in-vehicle device obtaining from a server and executing an application program for performing a process using a function of a vehicle, the in-vehicle device comprising:
a first obtainer configured to obtain basic information that is information on the function of the vehicle in which the in-vehicle device is installed;
a second obtainer configured to obtain additional information that is information on a peripheral device detachably attached to the vehicle;
an abstractor configured to convert the basic information and the additional information into abstracted information, the abstracted information being information in a common format independent from vehicle and the peripheral device; and
a provider configured to provide the server with the abstracted information as information for determining whether the application program is downloadable.

8. A usability determination method for determining usability of an application program in an in-vehicle device that is installed in a vehicle, the application program for performing a process using a function of the vehicle, the method comprising:
obtaining basic information that is information on the function of the vehicle in which the in-vehicle device is installed and additional information that is information on a peripheral device detachably attached to the installed vehicle;
converting the basic information and the additional information into abstracted information, the abstracted information being in a common format independent from the vehicle and the peripheral device; and
determining usability of the application program in the in-vehicle device by comparing a hardware requirement required for executing the application program that was designated and the abstracted information possessed by the in-vehicle device that executes the application program.
